(19) United States
(12) Patent Application Publication
(10) Pub. No.: US 2011/0149589 A1
(43) Pub. Date: Jun. 23, 2011

(54) OPTICAL DEVICE HAVING FLUOROCARBON POLYMER LAYER

(75) Inventors: Ming Ko, San Jose, CA (US); Wen-Jui Ray Chia, Sunnyvale, CA (US); Hong Fu, Pleasanton, CA (US)

(73) Assignee: AMS RESEARCH CORPORATION, Minnetonka, MN (US)

(21) Appl. No.: 13/056,436

(22) PCT Filed: Jul. 30, 2009
(86) PCT No.: PCT/US09/52214

§ 371 Date: Jan. 28, 2011

Related U.S. Application Data
(60) Provisional application No. 61/084,670, filed on Jul. 30, 2008.

(51) Int. Cl. F21V 8/00; G02B 6/24; B32B 37/12; B32B 37/14

(52) U.S. Cl. 362/553; 385/38; 156/293

(57) ABSTRACT

Embodiments of the invention are directed to an optical device, such as an optical device for use in a laser system. One embodiment of the optical device includes first and second components. A fluorocarbon polymer layer is between the first and second components. Embodiments of the fluorocarbon polymer layer comprise a fluorocarbon polymer in the form of an adhesive, an oil, a lubricant or a paste. In one embodiment, the fluorocarbon polymer layer is in the form of an adhesive that bonds the first and second components together.

### BACKGROUND

Medical lasers have been used in various practice areas, such as, for example, urology, neurology, otorhinolaryngology, general anesthetic ophthalmology, dentistry, gastroenterology, cardiology, gynecology, and thoracic and orthopedic procedures. Generally, these procedures require precisely controlled delivery of energy as part of the treatment protocol.

Surgical laser systems utilize a frequency doubled Nd:YAG laser, which operates at 532 nm in a quasi continuous mode at high power levels (e.g., 120 watts) and has been used to efficiently ablate tissue. The frequency doubled Nd:YAG laser can be pumped by CW krypton arc lamps and can produce a constant train of laser light pulses. When ablative power densities are used, a superficial layer of denatured tissue is left behind. At high powers, 532 nm lasers induce a superficial char layer that strongly absorbs the laser light and improves ablation efficiency.

Many surgical laser procedures utilize a surgical probe, which generally comprises an optical fiber coupled to a laser source, wherein the probe is positioned such that a probe tip can be positioned adjacent to the targeted tissue. Laser energy is directed through the optical fiber, out of the probe tip and onto desired portions of the targeted tissue. The probe tip can direct laser energy directly from the end of the tip of the optical fiber or can direct the laser energy toward targeted tissue. An example of a surgical probe is described in U.S. Pat. No. 5,428,699.

The probe tip can be a separate fiber cap component formed of quartz, such as a silica cap, that is coupled to a distal end of the silica optical fiber. The coupling of the fiber cap to the optical fiber can be accomplished by fusing the fiber cap to the optical fiber or by using an adhesive.

Fusing the probe tip to the optical fiber is an expensive process and can produce distortions of the optical fiber or the fiber cap that degrade the quality of the path the laser light travels through the distal end of the optical fiber and the fiber cap. This degradation of the laser light path can adversely affect the laser light that is discharged through the fiber cap.

Adhering the probe tip to the optical fiber has advantages of being a simple and inexpensive process while avoiding degrading the laser light path at assembly. However, the adhesive coupling of the fiber cap to the optical fiber has significant disadvantages, particularly when the fiber cap is used in high power laser systems. For instance, conventional adhesives, such as hydrocarbon and silicone adhesives (e.g., acrylates, epoxies and urethanes) including the Dymax® 128-M UV adhesive mentioned in the '699 patent, melt, degrade or carbonize during tissue irradiating procedures. If the adhesive becomes degraded or carbonized, then the degraded or carbonized adhesive layer can cause the amount of energy that can be delivered to the desired tissue location to be reduced while increasing the amount of energy absorbed by the probe and, more particularly, the probe tip. The degradation of the probe tip can cause fiber cap failures of devitrification, fiber cap detachment and fiber cap fractures during treatment of a patient.

Embodiments described herein provide solutions to these and other problems, and offer other advantages over the prior art.

### SUMMARY

Embodiments of the invention are directed to an optical device, such as an optical device for use in a laser system. One embodiment of the optical device (100) includes first and second components (102 and 104). A fluorocarbon polymer layer (110) is between the first and second components. Embodiments of the fluorocarbon polymer layer (110) comprise a fluorocarbon polymer in the form of an adhesive, an oil, a lubricant or a paste. In one embodiment, the fluorocarbon polymer layer is in the form of an adhesive that bonds the first and second components together.

In one embodiment, the first component comprises an optical fiber (142) that includes an optical fiber core (160), and the second component comprises a fiber cap (150) comprising a cap body (170) having an interior cavity (172) and an opening (174) to the interior cavity. A distal end (164) of the optical fiber core is received within the interior cavity of the fiber cap through the opening. The fluorocarbon polymer adhesive (110) bonds the fiber cap to the optical fiber.

In another embodiment of the optical device, the first component (102) comprises a first lens (192) and the second component (104) comprises a second lens (194). The first and second lenses are bonded together by the fluorocarbon polymer adhesive (110).

In another embodiment of the optical device (100), the first component (102) comprises a right angle prism (202) having first and second optical surfaces (208 and 212), and the second component (104) comprises a rhomboid prism (204) having an optical surface (210). The fluorocarbon polymer adhesive (110) bonds the first optical surface of the right angle prism to the optical surface of the rhomboid prism. In one embodiment, the optical device includes a half-wave plate (206) having an optical surface (214). A fluorocarbon polymer adhesive (110) bonds the optical surface of the half-wave plate to the second optical surface of the right angle prism.

Other features and benefits that characterize embodiments of the present disclosure will be apparent upon reading the following detailed description and review of the associated drawings.

### BRIEF DESCRIPTION OF THE DRAWINGS

FIG. 1 is an isometric view of an optical device in accordance with embodiments of the invention.

FIG. 2 is a side cross-sectional view of the optical device of FIG. 1 taken generally along line 2-2.

FIG. 3 is a simplified block drawing of an exemplary surgical laser system in accordance with embodiments of the invention.

FIGS. 4 and 5 are side cross-sectional views of exemplary optical devices in the form of a laser probe tip, in accordance with embodiments of the invention.

FIGS. 6 and 7 respectively show exploded and assembled examples of an optical device in the form of a focusing lens, in accordance with embodiments of the invention.

FIGS. 8 and 9 respectively show exploded and assembled isometric views of an example of an optical device in the form of a polarization beam combiner in accordance with embodiments of the invention.

FIG. 10 is a side cross-sectional view of the polarization beam combiner of FIG. 9 taken generally along line 10-10 with the size of some elements enlarged.

### DETAILED DESCRIPTION OF ILLUSTRATIVE EMBODIMENTS

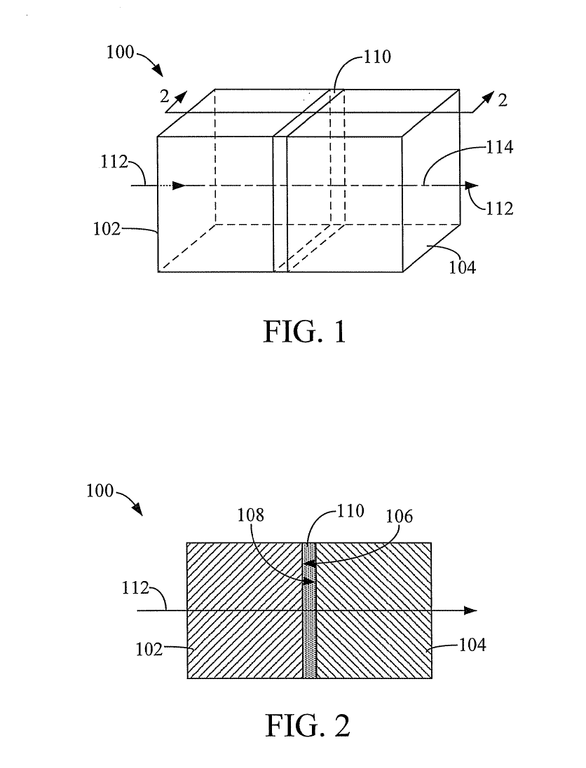

Embodiments of the present invention relate to an optical device that is assembled using a fluorocarbon polymer adhesive. FIG. 1 is an isometric view of an optical device 100 in accordance with embodiments of the invention. FIG. 2 is a side cross-sectional views of the optical device 100 of FIG. 1 taken generally along line 2-2.

One embodiment of the optical device 100 comprises at least two components 102 and 104 that form at least a portion of the device 100. The component 102 includes a surface 106 and the component 104 includes a surface 108. A fluorocarbon polymer layer 110 is positioned between the surfaces 106 and 108 of the components 102 and 104.

The fluorocarbon polymer layer 110 can take on many different forms. In one embodiment, the fluorocarbon polymer layer 110 is in the form of a lubricant. In another embodiment, the fluorocarbon polymer layer 110 is in the form of a gel or paste. In another embodiment, the fluorocarbon polymer layer 110 is in the form of a liquid. In another embodiment, the fluoropolymer coating 110 is in the form of a solid.

In one embodiment, the fluorocarbon polymer layer 110 is in the form of an adhesive (hereinafter “fluorocarbon polymer adhesive 110”) that bonds the first and second components 102 and 104 together to form at least a portion of the device 100. In one embodiment, a coupling agent (not shown), such as silane (SiH₄) or other suitable coupling agent, is used between one or both of the surfaces 106 and 108 and the fluorocarbon polymer adhesive 110.

Exemplary optical devices 100 include elements of laser surgical laser systems, probe tips (i.e., fiber caps), beam polarization combiners (e.g., PMUX), lenses, focusing lenses, laser crystals, beam splitters, laser probes, optical shutters, Q-switches, waveplates, prisms, windows, mirrors, optical pick-ups, aiming diodes, couplers, optical homogenizers, fiber converters, SMA (SubMiniature version A) connectors, optical fiber connectors, fiber adapters, and other optical devices. In one embodiment, the components 102 and 104 of the optical device 100 are components through which laser light 112 travels during conventional use of the device 100, as illustrated in FIGS. 1 and 2. In one embodiment, the path 114 of the laser light 112 that travels through the optical device 100 during conventional use of the device 100 passes through the components 102 and 104 as well as the fluorocarbon polymer layer 110. That is, the device 100 is conventionally used to perform an optical function, such as combining laser beams (e.g., a combiner), splitting a laser beam (e.g., beam splitter), or other optical function, and, while performing said optical function, the laser light travels through the component 102, the fluorocarbon polymer layer 110 and the component 104.

Exemplary embodiments of the components 102 and 104 of the device 100 include an optical fiber, a lens, a prism, a fiber cap, a fiber optic core, a minor, a waveplate, glass, an optical pick-up, an aiming diode, a coupler, an optical homogenizer, a fiber converter, a SMA connector, an optical fiber connector, a fiber adapter, and other optical components used to form optical devices. Other exemplary embodiments of the components 102 and 104 include structural elements, such as a frame or portion thereof, a housing portion thereof, or other element used to form the optical device 100. In accordance with other embodiments, the surfaces 106 and 108 of the components 102 and 104 are glass surfaces.

Embodiments of the fluorocarbon polymer layer 110 comprise at least one fluorocarbon polymer. The term “fluorocarbon polymer,” as used herein, is a perfluoro or fluorocarbon polymer (fluoropolymer) or oligomer. Exemplary fluorocarbon polymers suitable for use in forming the layer 110 are marketed under the trade names Cytop™, Krytox®, Fomblin® Z DOL, and others.

Embodiments of the fluorocarbon or perfluoro compound have a molecular weight in the range of 1000 to 1,000,000 oligomers or polymers. In one embodiment, the fluorocarbon polymer layer 110 comprises at least one fluorocarbon or perfluoro compound with a molecular weight in the range of 6,000 to 7,000 oligomers or polymers. In one embodiment, the fluorocarbon polymer layer 110 comprises two or more fluorocarbons, each having a molecular weight in the range of oligomers or polymers.

Embodiments of the fluorocarbon polymer layer 110 include a fluorocarbon polymer that is 100% solid or pre-dissolved in a suitable solvent, such as a perfluoro solvent, in the range of 1-100% non-volatile matters (NVM). Preferably, the perfluoro or fluorocarbon polymer is pre-dissolved in a suitable solvent in the range of 0.5-50% non-volatile matters (NVM). Exemplary solvents include solvents or diluents related to fluorocarbons, such as 3M Fluorinerts® or Novec® (FC solvents), and Asahi Glass AK-255 (HCFC solvent).

The fluorocarbon polymer layer 110 is generally non-flammable and is resistant to extreme temperatures, such as from about −100° C. to about 470° C. Further, the inventors have discovered that the fluorocarbon polymer layer 110 is laser resistant and does not burn upon laser irradiation, such as that produced by surgical laser systems.

The fluorocarbon polymer layer 110 is also chemically resistant and inert, especially to bodily fluids and other bio fluids. The fluorocarbon polymer layer 110 has also been found to have high lubricity, good thermal qualities, good adhesion to glass and metal surfaces, and is low or non-absorbing at the ultraviolet (UV), visible, and near infrared (IR) spectra wavelengths. Thus, the fluorocarbon polymer layer 110 does not substantially affect laser beams operating within these spectrums.

Experiments have shown that, unlike the conventional adhesives mentioned above, the fluorocarbon polymer adhesive 110 does not degrade under typical high power surgical laser irradiation. This provides a significant advantage over conventional hydrocarbon and silicone adhesives, such as acrylates, epoxies, urethanes. The inventors have discovered that these properties of the fluorocarbon polymer adhesive 110 make it uniquely suited to the bonding of the components 102 and 104 to form the optical device 100. Thus, the fluorocarbon polymer adhesive 110 can successfully replace the commonly used UV-cured, silicone, and other types of adhesives, coatings, films, shrink tubes and plastics in optical devices, particularly those of laser systems.

The other forms of the fluorocarbon polymer layer 110 can also provide benefits to the components 102 and 104 of the optical device 100. For example, the fluorocarbon polymer layer 110 can provide protection of the component at the interface between the surfaces 106 and 108, for example.

One embodiment of the invention is directed to a method of assembling the optical device 100 with the fluorocarbon polymer adhesive 110. In one embodiment, the fluorocarbon polymer adhesive 110 is applied to one or both of the surfaces 106 and 108 to be bonded together. In one embodiment, the fluorocarbon polymer adhesive 110 is pre-cured by cross-linking at elevated temperatures such as in an oven before its application to the surfaces 106 and 108. The amount of the fluorocarbon polymer adhesive 110 that is applied depends on the components. Exemplary amounts are in the range of micrograms to tens of grams. In one embodiment, a coupling agent is applied to one or both of the surfaces 106 and 108 prior to the application of the fluorocarbon polymer adhesive 110 to the surfaces 106 and/or 108. The fluorocarbon polymer adhesive 110 may be applied to the surfaces 106 and/or 108 using a sprayer, a dropper, a swab applicator, a transfer applicator, a needle, a brush, or other suitable applicator. Alternatively, the fluorocarbon polymer adhesive 110 may be applied to the surface 106 and/or 108 using a deposition technique, such as chemical vapor deposition (CVD) or physical vapor deposition (PVD) techniques.

Following the application of the fluorocarbon polymer adhesive 110, the surfaces 106 and 108 are brought together with the fluorocarbon polymer adhesive 110 in between, as shown in FIG. 1. In one embodiment, pressure is applied to the components 102 and 104 to press the surfaces 106 and 108 toward each other.

In one embodiment, the components 102 and 104 are pre-heated before or after the application of the fluorocarbon polymer adhesive 110 to the surfaces 106 and 108 and prior to joining the components together. In one embodiment, the components 102 and 104 are pre-heated to a temperature of approximately 70° C. to 250° C. for about 1-60 minutes. In one embodiment, a vacuum is applied to speed the pre-heating step.

In one embodiment, the components 102 and 104 are heated after the components are brought together for final curing of the fluorocarbon polymer adhesive 110. In one embodiment, the components 102 and 104 are heated to approximately 120-350° C. for 1-500 minutes. In one embodiment, a vacuum is applied to speed the curing step.

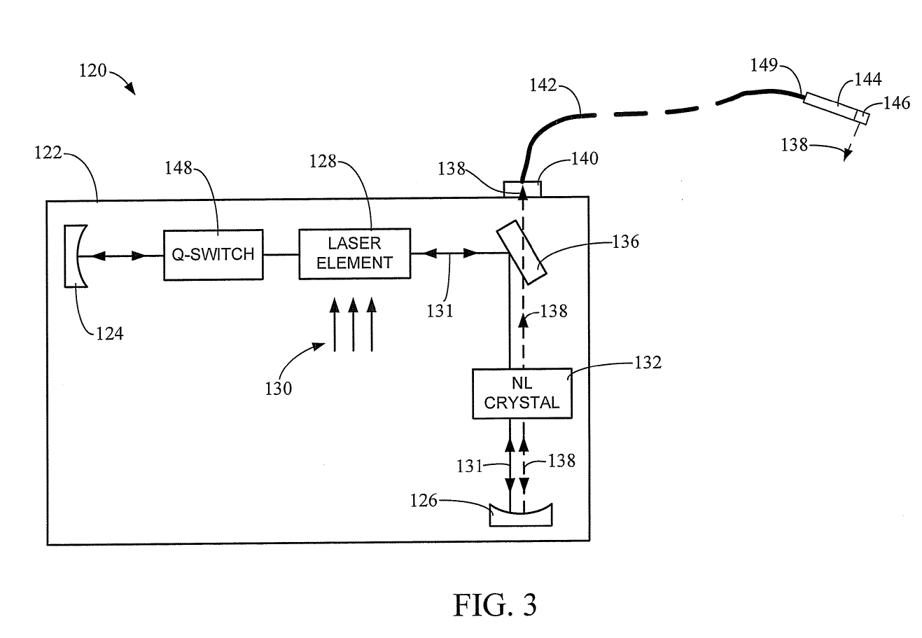

As mentioned above, embodiments of the optical device 100 include devices or elements of a surgical laser system. FIG. 3 is a simplified block drawing of an exemplary surgical laser system 120, in which an optical device 100 in accordance with embodiments of the invention may be utilized. The exemplary system 120 comprises a laser resonator 122. The exemplary laser resonator 122 may include a first resonator minor 124, a second resonator minor 126 and a laser rod or element 128. In one embodiment, the laser element 128 comprises a yttrium-aluminum-garnet crystal rod with neodymium atoms dispersed in the YAG rod to form a Nd:YAG laser element. Other conventional laser elements 128 may also be used.

The laser element 128 is pumped by a light input 130 from an optical pump source, such as a Kr arc lamp or other conventional optical pump source, to produce laser light or beam 131 at a first frequency. The laser resonator 122 also includes a nonlinear crystal (NLC) 132, such as a lithium borate (LBO) crystal or a potassium titanyl phosphate crystal (KTP), for generating a second harmonic of the laser beam 131 emitted by the laser element 128. The laser beam 131 inside the resonator 122 bounces back and forth between the first and second resonator minors 124 and 126, reflects off a folding mirror 136 and propagates through the laser element 128 and nonlinear crystal 132. The laser element 128 has optical gain at a certain wavelength and this determines the wavelength of the laser beam 131 inside the resonator 122. This wavelength is also referred to as the fundamental wavelength. For the Nd:YAG laser element 128, the fundamental wavelength is 1064 nm.

When the laser beam 131 inside the resonator 122 propagates through the nonlinear crystal 132 in a direction away from the folding minor 136 and toward the second resonator minor 126, a beam 138 of electromagnetic radiation at the second harmonic wavelength is output from the crystal 132. The second resonator minor 126 is highly reflective at both the fundamental and second harmonic wavelengths and both beams 131 and 138 propagate back through the nonlinear crystal 132. On this second pass, more beams 138 at the second harmonic wavelength are produced. For example, the nonlinear crystal 132 can produce a laser beam 138 having a wavelength of approximately 532 nm (green) when a Nd:YAG rod is used as the laser element 128. One advantage of the 532 nm wavelength is that it is strongly absorbed by hemoglobin in blood and, therefore, is useful for cutting, vaporizing and coagulating vascular tissue.

The folding minor 136 is highly reflective at the fundamental wavelength and is highly transmissive at the second harmonic wavelength and hence the laser beam 138 at the second harmonic passes through the folding minor 136 and produces a second harmonic laser beam 138 outside the optical resonator 122. An optical coupler 140 is connected to a waveguide, such as a fiber optic cable 142, to deliver the laser beam 138 to a laser delivery probe 144, having a probe tip 146, such as a side-fire fiber cap, that delivers the beam 138 to desired tissue for treating a condition of the patient.

The laser beam 131 inside the resonator 122 at the fundamental wavelength continues through the laser element 128 and reflects off the first resonator mirror 124 which is highly reflective at the fundamental wavelength. A Q-switch 148 may be used in the resonator 122 to change the laser beam 131 to a train of short pulses with high peak power. These short pulses increase the conversion efficiency of the second harmonic laser beam 138 and increase the average power of the laser beam 138 outside the resonator 122.

Embodiments of the optical device 100 include the components of the laser system 120 described above as well as components of other types of laser systems. As mentioned above, embodiments of the optical device 100 include a probe tip, such as probe tip 146 (FIG. 3). Probe tips 146 are often in the form of a fiber cap that is attached to a distal end 149 of the optical fiber 142. Fiber caps can take on many different forms and can be designed to direct or discharge the laser beam in many different ways.

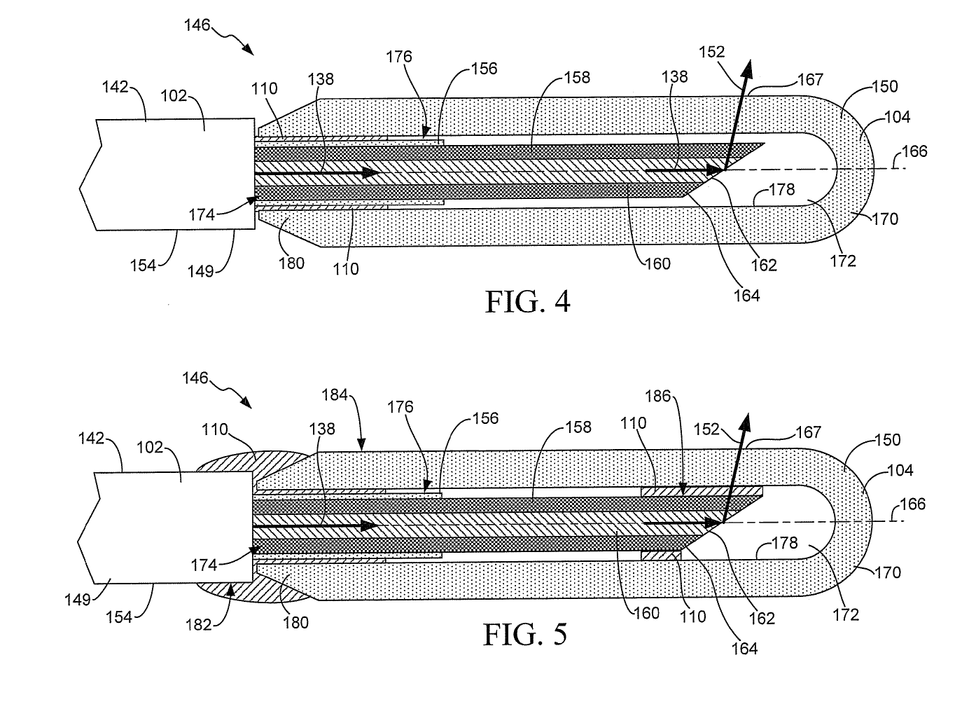

FIGS. 4 and 5 are side cross-sectional views of exemplary optical devices 100 in the form of a laser probe tip 146. Embodiments of the probe tip 146 comprise an optical fiber 142 (component 102) attached to a fiber cap 150 (component 104). While the exemplary fiber caps 150 are illustrated as side-fire fiber caps that operate to direct the laser beam 138 laterally, as indicated at 152, it is understood that embodiments of the invention include fiber caps directing the light in other directions.

Embodiments of the optical fiber 142 generally comprise a nylon jacket 154, a buffer or hard cladding 156, cladding 158 and an optical fiber core 160. It is understood that other forms of optical fibers may also be used. The optical fiber core 160 operates as a waveguide through which electromagnetic energy, such as laser beam 138 (FIG. 1), travels. In one embodiment, the nylon jacket 154 and at least a portion of the hard cladding 156 is removed from the distal end 149 to expose the cladding 158, as illustrated in FIGS. 4 and 5. In one embodiment, a polished optical surface 164 is formed at the distal end 154 of the optical fiber core 160 in accordance with conventional techniques. In one embodiment, the polished optical surface 162 is non-perpendicular to the longitudinal axis 166 of the optical fiber core 160, as illustrated in FIGS. 4 and 5. Such a beveled surface 162 operates to reflect the laser light 138 laterally through a transmitting surface 167 as indicated by arrow 152. The surface 162 can take on other conventional configurations to direct the output laser beam 152 in a desired direction.

Embodiments of the fiber cap 150 include a cap body 170 having an interior cavity 172 and an opening 174 to the interior cavity 172. The distal end 164 of the optical fiber core 160 is received within the interior cavity 172 through the opening 174. In one embodiment, the cap body 170 seals the interior cavity 172 except at the opening 174.

In one embodiment, the cap body 170 is bonded to the optical fiber 142 using the fluorocarbon polymer adhesive 110. In one embodiment, the adhesive 110 is located between the exterior surface 176 (surface 106) of either the hard cladding 156 or the cladding 158, and the interior surface 178 (surface 108) of the cap body 170 that defines the interior cavity 172. In one embodiment, the fluorocarbon polymer adhesive 110 covers a portion of the exterior surface 182 of the optical fiber 142 and the exterior surface 184 of the cap body 170, as shown in FIG. 5.

In one embodiment, the fluorocarbon polymer adhesive 110 is located at a proximal end 180 of the cap body 170. In accordance with another embodiment, the fluorocarbon polymer adhesive 110 is located proximate the distal end 164 of the fiber optic core 160, as shown in FIG. 5. In one embodiment, the fluorocarbon polymer adhesive 110 is located between an exterior surface 186 of the fiber optic core 160 and the interior surface 178 of the cap body 170.

In one embodiment, the fluorocarbon polymer adhesive 110 is located within a laser path (arrows 138 and 152) of the laser beam 152 that is discharged through the fiber cap 150, as shown in FIG. 5. The laser path is generally defined by the distal end 164 of the optical fiber core 160. The location of the fluorocarbon polymer adhesive 110 can be adjusted depending on the particular configuration of the surface 162 of the optical fiber core 160.

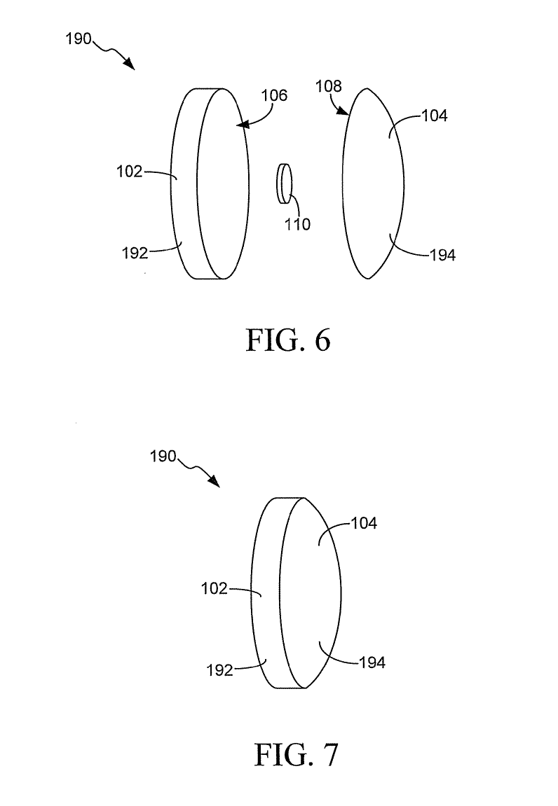

Another specific example of the optical device 100 that can be formed in accordance with embodiments of the invention is a focusing lens for multi-wavelength laser beams, an example of which is illustrated in FIGS. 6 and 7. FIG. 6 is an exploded isometric view of the focusing lens 190 and FIG. 7 is an assembled isometric view of the focusing lens 190, in accordance with embodiments of the invention. The focusing lens 190 comprises a convex lens 192 (component 102), a concave lens 194 (component 104) and the fluorocarbon polymer adhesive 110 between the lenses 192 and 194. The lens 192 includes a surface 106, which is preferably a polished optical surface. Similarly, lens 194 includes a surface 108, which is preferably a polished optical surface. The fluorocarbon polymer adhesive 110 operates to bond the surfaces 106 and 108 of the lenses 192 and 194 together to form the assembled focusing lens 190 shown in FIG. 7.

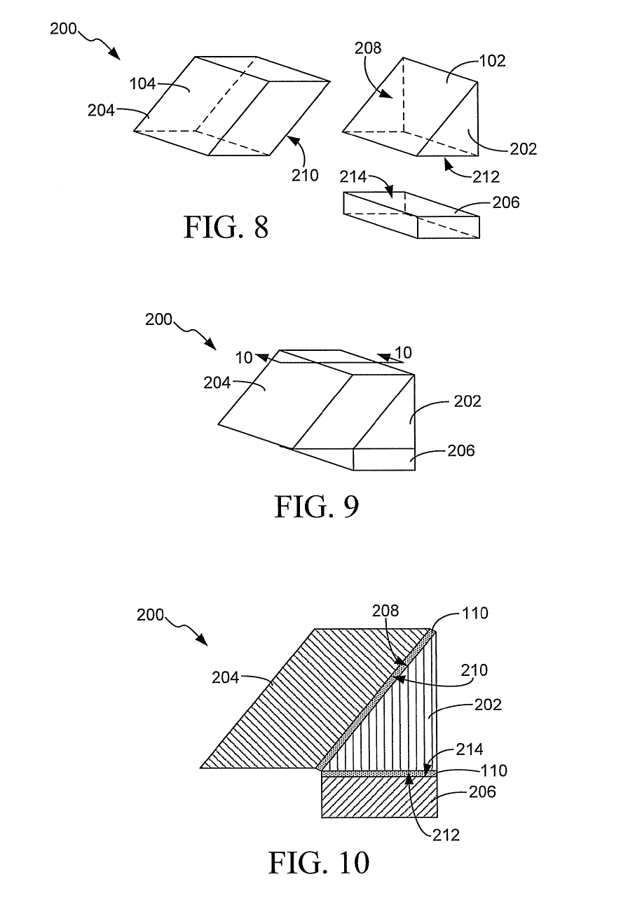

Another specific example of the optical device 100 that can be formed in accordance with embodiments of the invention is a beam polarization combiner, an example of which is illustrated in FIGS. 8-10. FIG. 8 is an exploded isometric view of the combiner 200 and FIG. 9 is an assembled isometric of the combiner 200, in accordance with embodiments of the invention. FIG. 10 is a side-cross sectional view of the combiner 200, with the size of some portions increased to make them visible. Accordingly, the drawing is not to scale. The combiner 200 generally operates in accordance with conventional beam combiners.

One embodiment of the polarization beam combiner 200 comprises a right angle prism 202, a rhomboid prism 204 and a half-wave plate 206. In accordance with one embodiment of the invention, the right angle prism 202 and the rhomboid prism 204 are coupled together using the fluorocarbon polymer adhesive 110, as shown in FIG. 10. The size of the fluorocarbon polymer adhesive 110 illustrated in FIG. 10 is exaggerated to make the layer visible, but would normally be much smaller. The fluorocarbon polymer adhesive 110 operates to bond an optical surface 208 of the right angle prism 202 to an optical surface 210 of the rhomboid prism 204. As a result, the one embodiment of the optical device 100 comprises the right angle prism 202 (component 102) bonded to the rhomboid prism 204 (component 104) by the fluorocarbon polymer adhesive 110.

In one embodiment, the right angle prism 202 includes an optical surface 212 that is bonded to an optical surface 214 of the half-wave plate 206 by a layer of fluorocarbon polymer adhesive 110, as shown in FIG. 10. As mentioned above, the size of the layer of fluorocarbon polymer adhesive 110 is exaggerated to make the layer visible in FIG. 10. Accordingly, one embodiment of the optical device 100 comprises the right angle prism 202 (component 102) bonded to the half-wave plate 206 (component 104) by the fluorocarbon polymer adhesive 110.

Although specific examples of embodiments of the invention have been illustrated and described herein, workers skilled in the art will recognize that changes may be made in form and detail without departing from the spirit and scope of the invention. Accordingly, this application is intended to cover adaptations or variations of the presented subject matter that fall within the spirit and scope of the embodiments of the invention described herein.

1-20. (canceled)

21. An optical device comprising:
an optical fiber including an optical fiber core;
a fiber cap comprising a cap body having an interior cavity and an opening to the interior cavity, wherein a distal end of the optical fiber core is received within the interior cavity through the opening; and
and fluorocarbon polymer layer between the fiber cap and the optical fiber.

22. The device of claim 21, wherein the fluorocarbon polymer layer comprises a fluorocarbon polymer adhesive.

23. The device of claim 22, wherein the fluorocarbon polymer adhesive covers a portion of the cap body adjacent the opening and a portion of the optical fiber.

24. The device of claim 23, wherein the fluorocarbon polymer adhesive covers a portion of the cap body adjacent the opening and a portion of a jacket of the optical fiber surrounding the optical fiber core.

25. The device of claim 22, wherein the fluorocarbon polymer adhesive is between an exterior surface of the distal end of the optical fiber core and an interior surface of the cap body.

26. The device of claim 21, wherein:
laser light transmitted through the optical fiber travels along a laser path through the optical fiber and the fiber cap; and
the fluorocarbon polymer adhesive is located within the laser path.

27. The device of claim 26, wherein the optical fiber core includes a beveled optical surface.

28. A laser system comprising:
a laser resonator configured to output a laser beam;
an optical fiber having a proximal end coupled to the laser resonator, the optical fiber including an optical fiber core configured to transmit the laser beam;
a fiber cap comprising a cap body having an interior cavity and an opening to the interior cavity, wherein a distal end of the optical fiber core is received within the interior cavity through the opening; and
and fluorocarbon polymer layer between the fiber cap and the optical fiber core.

29. The system of claim 28, wherein the fluorocarbon polymer layer comprises a fluorocarbon polymer adhesive.

30. The system of claim 29, wherein the fluorocarbon polymer adhesive covers a portion of the cap body adjacent the opening and a portion of the optical fiber.

31. The system of claim 30, wherein the fluorocarbon polymer adhesive covers a portion of the cap body adjacent the opening and a portion of a jacket of the optical fiber surrounding the optical fiber core.

32. The system of claim 29, wherein the fluorocarbon polymer adhesive is between an exterior surface of the distal end of the optical fiber core and an interior surface of the cap body.

33. The system of claim 28, wherein:
the laser beam travels along a laser path through the optical fiber and the fiber cap; and
the fluorocarbon polymer adhesive is located within the laser path.

34. The system of claim 33, wherein the laser resonator comprises:
a laser element configured to emit laser light having a first frequency responsive to a light input; and
a nonlinear crystal configured to increase the frequency of the emitted laser light to a second frequency, which is higher than the first frequency.

35. A method comprising:
providing an optical fiber including an optical fiber core;
providing a fiber cap comprising a cap body having an interior cavity and an opening to the interior cavity;
inserting a distal end of the optical fiber core through the opening and into the interior cavity of the cap body; and
bonding the cap body to the optical fiber using a fluorocarbon polymer adhesive.

36. The method of claim 35, wherein bonding the cap body to the optical fiber comprises applying the fluorocarbon polymer adhesive to at least one of a surface of the optical fiber and a surface of the cap body and placing the surfaces in contact with each other.

37. The method of claim 36, wherein applying the fluorocarbon polymer adhesive occurs prior to inserting a distal end of the optical fiber core through the opening and into the interior cavity of the cap body.

38. The method of claim 35, further comprising pre-curing the fluorocarbon polymer adhesive before bonding the cap body to the optical fiber.

39. The method of claim 35, further comprising heating the optical fiber and the cap body to a temperature of approximately 70°-250° C.

40. The method of claim 35, further comprising transmitting laser light through the optical fiber core, the cap body and the fluorocarbon polymer adhesive.
